(19) United States
(12) Patent Application Publication
(10) Pub. No.: US 2010/0194988 A1
(43) Pub. Date: Aug. 5, 2010

(54) Method and Apparatus for Enhancing Highlight Detection

(75) Inventors: Hiroshi Takaoka, Tsukuba (JP); Masato Shima, Tsukuba (JP)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/366,065

(22) Filed: Feb. 5, 2009

(51) Int. Cl. H04N 9/74

(52) U.S. Cl. 348/578; 348/E09.055

(57) ABSTRACT

A method and apparatus for highlight detection. The method includes retrieving audio and video data, detecting a high audio energy scene of the retrieved audio data, detecting a key-line scene relevant to the high audio scene of the retrieved video data, detecting an in-play scene according to the key-line, and optimizing start and end point of the highlight scene.

### BACKGROUND OF THE INVENTION

1. Field of the Invention

Embodiments of the present invention generally relate to a method and apparatus for enhancing highlight detection; more specifically, a method and apparatus for enhancing highlight detection technique for video content with desirable start and end point.

2. Background of the Invention

Through the evolution of video recoding devices over past decades, consumers are capable of having various opportunities to record and store video materials. In the past, most of the video materials were recorded into video cassettes. Later, the majority of recording media shifted to optical discs such as CD and DVD. Recently, due to its downward price trend, HDD has been becoming the most popular storage for multimedia materials recording. Furthermore, the price decline of HDD has promoted the evolution of video recording devices.

The recent set-top boxes and video recorders are usually capable of simultaneously recording multiple broadcasted TV materials. However, such capability causes a problem of watching time scarcity; for example, the time for today's consumer to playback those recorded materials is limited and unchanged. Accordingly, there is a strong demand to watch video materials with much shorter time. To resolve the issue, there are two approached: (1) accelerating playback speed is utilized to resolve the problem; and (2) detecting and extracting only the scenes with important events of the materials and saving watching time by skipping non-important scenes at playback time.

Utilizing the second approach, every scene of video materials is evaluated and accordingly classified. Most conventional studies utilize the various audio characteristics of each scene. Given the number of samples processed over a certain time frame, video signal processing is usually more complex than audio signal processing. However, there is useful information for the highlight detection that can be found in the video signal processing.

Since audio based techniques tend to require less computational intensity than video based techniques, the conventional scene classification is mostly based on audio techniques. One of the most popular audio techniques is the method based on audio energy. The method divides the entire frequency spectrum into several sub-bands and utilizes the short time energy of each sub-band. The method then ranks and classifies each scene depending on the computed sub-band short-time energies.

Especially for sports video contents, the highlight scenes (e.g. scoring opportunities, fine plays, etc.) tend to have strong correlation with the energy of the audio signal for the moment, for example, cheers, applause of audience and excited speech of announcers tend to occur in sporting events. Consequently, extracting the scenes from sports video and/or image contents with high audio energy mostly result in the good summarization of the entire game. For the purposes of this invention, highlight scenes are scenes that are of special or greater interest to an audience.

However, since cheers and applause of audience as well as excited speech of announcers often occur after such highlight scenes, the audio energy based technique tends to detect and extract only a limited portion of the highlight scenes. In most cases, this problem seemed to be handled by setting the time margin before the audio energy peak. Due to the variation in each highlight scene, it is difficult to estimate the ideal start point from the audio signal alone. Setting the time margin long enough to cover every action of highlight scenes results in the degradation of the extracted highlight by extracting unwanted scenes in any other cases.

Therefore, there is a need for a highlight detection technique that detects the start point of a highlight scene while avoiding unwanted scenes.

### SUMMARY OF THE INVENTION

Embodiments of the present invention relate to a method and apparatus for highlight detection. The method includes retrieving audio and video data, detecting a high audio energy scene of the retrieved audio data, detecting a key-line scene relevant to the high audio scene of the retrieved video data, detecting an in-play scene according to the key-line, and optimizing start and end point of the highlight scene.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a block diagram depicting data streaming system;

FIG. 2 is an embodiment of a block diagram depicting highlight detection device;

FIG. 3 is an embodiment of a block diagram depicting activity of a highlight detection;

FIG. 4 is an embodiment of an image presenting various areas of the image;

FIG. 5 is a flow diagram depicting an embodiment of an audio based method;

FIG. 6 is a flow diagram depicting an embodiment of a key scene detection method;

FIG. 7 is a flow diagram depicting an embodiment of an in-play scene detection;

FIG. 8 is a flow diagram depicting an embodiment of a start and end point optimization method; and

FIG. 9 is an embodiment depicting highlight detection performance improvement as a result of the current invention.

### DETAILED DESCRIPTION

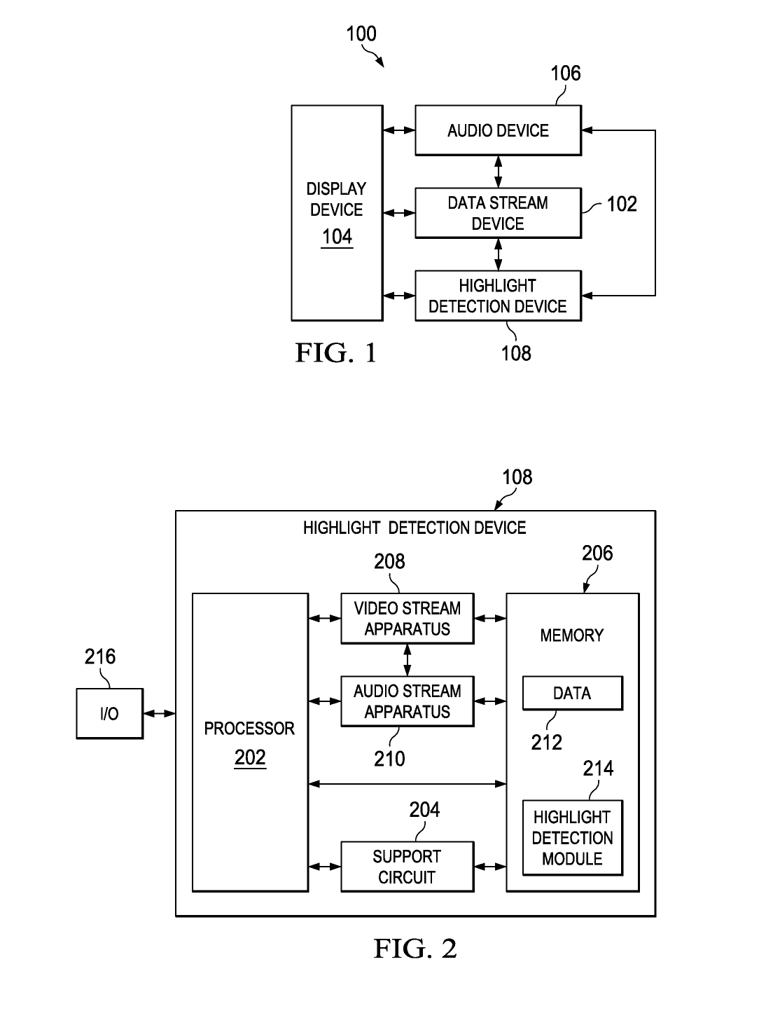

FIG. 1 is an embodiment of a block diagram depicting data streaming system 100. The highlight detection system 100 includes a data stream device 102, display device 104, audio device 106 and a highlight detection device 108. The data stream device 102 is any device that is well known in the art utilized for providing streaming data, such as, video, audio and the like. For example, the data stream device may be associated with a cable box, a satellite, etc. The data stream device 102 may be capable of recording data stream, i.e. archiving data for later use or display. The data stream device 102 may be coupled to a highlight detection device or may include a highlight detection device therein. The data stream device 102 may receive streaming data from outside source, such as, a cable or satellite company, may only play archived streaming, or combination thereof.

The display device 104 displays the streaming data, such as, video, images and the like. The display device 104 may be an LCD screen, a television screen, a DLP projection device, a monitor or any display mechanism. The display device 104 may receive data from the data stream device 102 or the highlight detection device 108. The audio device 106 is a device capable of receiving and/or sounding audio data from the data stream device 102 or the highlight detection device 108. The audio device 106 may be a speaker, amplifier, etc. The audio device 106 may be coupled to or included within the display device 104, data stream device 102 and/or highlight detection device 108. The highlight detection device 108 is described in FIG. 2.

FIG. 2 is an embodiment of a block diagram depicting highlight detection device 102. The highlight detection device 102 includes a processor 202, support circuit 204, memory 206, video stream apparatus 208, and audio stream apparatus 210.

The processor 202 may comprise one or more conventionally available microprocessors. The microprocessor may be an application specific integrated circuit (ASIC). The support circuits 204 are well known circuits used to promote functionality of the processor 202. Such circuits include, but are not limited to, cache, power supplies, clock circuits, input/output (I/O) circuits and the like. The memory 204 may comprise random access memory, read only memory, removable disk memory, flash memory, and various combinations of these types of memory. The memory 204 is sometimes referred to as main memory and may, in part, be used as cache memory or buffer memory. The memory 204 may store an operating system (OS), software, firmware, and data, such as, data 212 and highlight detection module 214, and the like. It should be noted that a computer readable medium is any medium utilized by a computer system for storing and/or retrieving data. The highlight detection device 108 may be coupled or may include an input/output device 216,

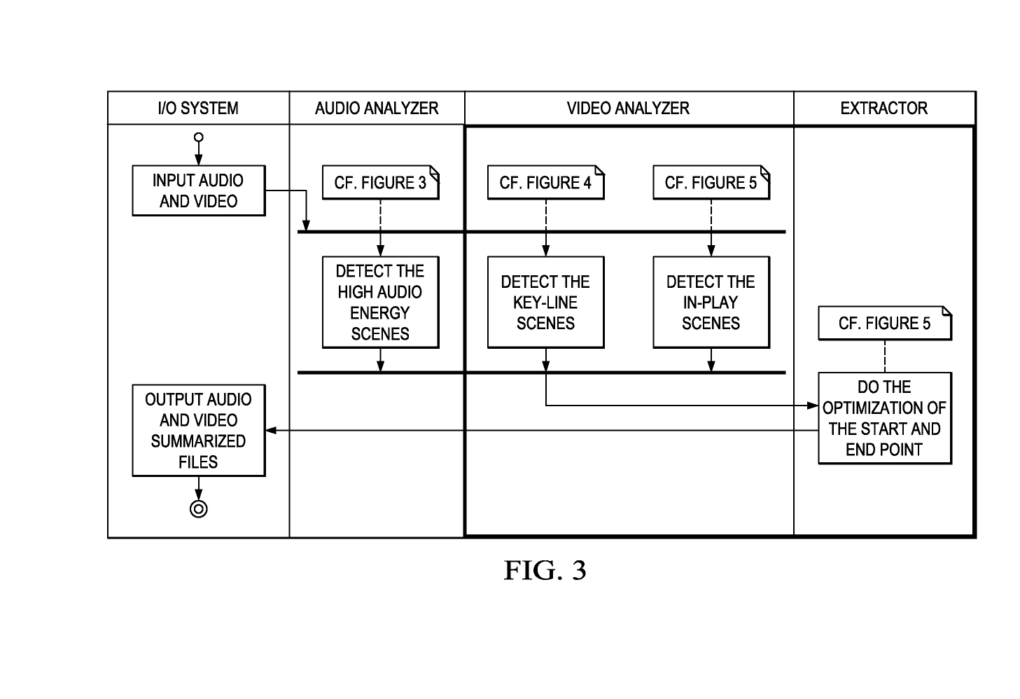

The data 212 is any data that the highlight detection device 108 archives or utilized. The highlight detect module 214 detects highlight scene from streaming data. The streaming data may be archived data being streamed at a later time or a real-time streaming data. The highlight detect module 214 performs the activity described in FIG. 3. The highlight detect module 214 utilizes video based technique to detect highlight scenes. By utilizing video based techniques, the key scenes extraction that includes the start point of all highlight scenes (e.g. pitching plays by a pitcher for baseball, plays occurring near the goal for soccer, etc.) will be achieved.

FIG. 3 is an embodiment of a block diagram depicting activity of highlight detection module 214. Usually, the start point of highlight scenes tends to contain key-lines in the particular area of the image. A start point of a highlight scene, such as, a pitching play for baseball, a play happening near the goal for soccer etc. may be considered as one of the key scenes. A key-line is the line that is detected in a key scene. For example, in case of baseball, the key-line is a horizontal line in the middle area of the image. (e.g. the boundary of the field and audience seat, the boundary of the diamond, i.e. grass color, and batter's box, i.e. ground color, etc.) In case of soccer, a highlight scene tends to happening around a goal, thus, the goal tends to be an optimal start point. Therefore, the key-line is the line that is parallel to goal line (e.g. penalty area line, bar of the goal, etc.). In most cases, those lines may appear skewed, because the main camera tends to be located in the middle of a side line.

As shown in FIG. 3, through the Input/output (I/O) system, the input audio and video data is retrieved. An audio analyzer analyzes the audio input and detects the high audio energy. A video analyzer analyzes image/video data and detects key-line scenes and in-play scenes. In accordance with the current invention, an extractor utilizes the detected information and optimizes the start and end points, which are included in an output audio and video/image summarized files and utilized by the I/O system.

In-play scenes tend to include dominant color in a particular area. The dominant color is the color that exists in a certain color range. The color range is decided based on the statistical analysis relating to an object of interest in an image, such as, grass, ground, human's skin etc. Highlight scene color space is used and a dominant color is computed statistically, such as, calculating the average in selected area by the following equation (1) and standard deviation to get the minimum and maximum value of the dominant color (2).

$$\begin{matrix}{domColAvg}_{c} ≡ {\sum }_{i ∈ selected area} {pixVal ( i )}_{c} ( c = H , L , S ) & ( 1 ) \\ {domCol Max [ Min ]}_{c} , ≡ {domColAvg}_{c} + [ - ] a {σ}_{c} ( c = H , L , S ) & ( 2 )\end{matrix}$$

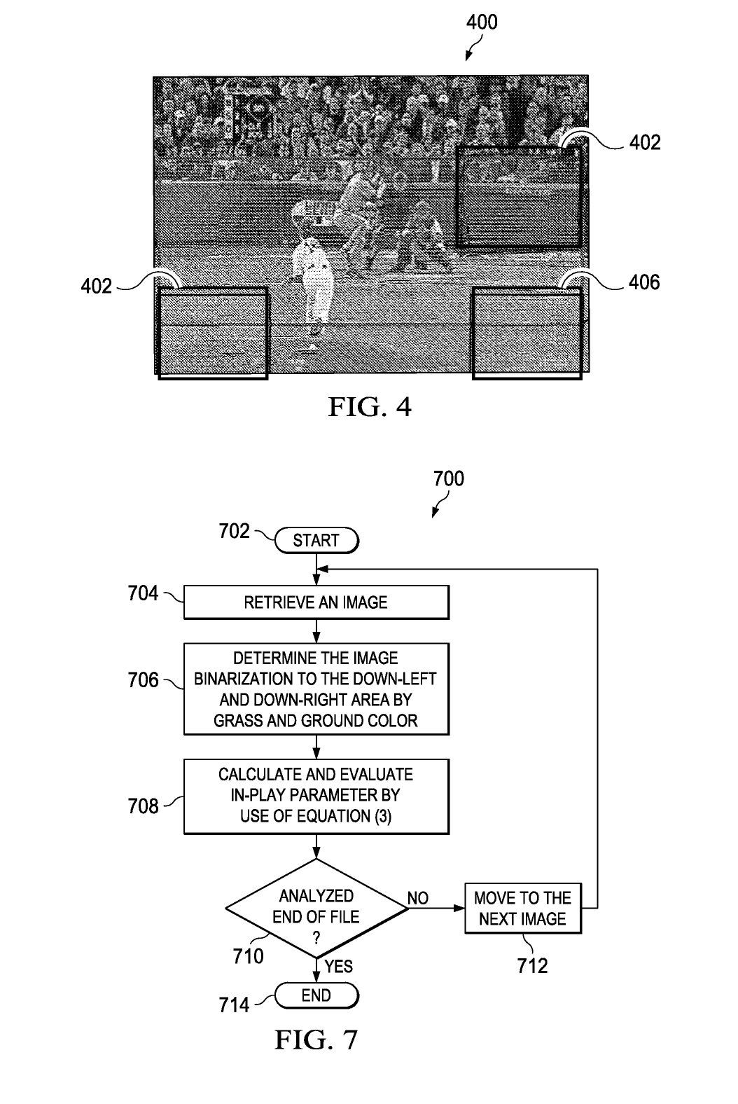

For example, in case of baseball, the dominant colors are grass and ground color in the down area of the image. In case of soccer, however, dominant color is a grass color in the down area of the image, as shown in FIG. 4. In this paper, baseball games are used as an example of highlight detection due to its popularity and characteristics.

The middle rectangle 402, shown in FIG. 4, is used as the selected area and the grass dominant color in image 400 color space, which is used as the dominant color for binarization. The 8-neighbor Laplacian filter is used for the edge detection. Then, non-horizontal lines are removed as the noise canceling process in this case to improve the detection accuracy. The newly developed simple line-segment detection algorithm is used as a line-detection algorithm. Generally, Hough transformation is believed to be the most popular and well-used line detection algorithm.

However, in order to take advantage of the characteristics of horizontal lines, the line-segment detection algorithm is used instead, which eventually reduce the computational intensity of line detection. The line-segment detection algorithm is a method utilized to detect horizontal (vertical) lines that detects line-segments over a decided threshold length, and to evaluate the image that includes the key-line, if the count of the detected segments is exceed the threshold or maximum length of the detected segment exceed the threshold.

The down-left rectangle 404 and down-right rectangle 406, shown in FIG. 4, are used as the selected area, because the down-center rectangle is often occupied by players even if it is in-play scene. Also, the grass and ground dominant color is used as a factor for binarization. In-play parameter of the baseball game is defined by equation (3) and classification of each scene is done depending on the in-play parameter.

$$DomColRate ( rect ) ≡ {\sum }_{i ∈ Rect} p ( i ) / N ( p = \{ \begin{matrix}1 \text{:} & ( \begin{matrix}included in \\ dominant color\end{matrix} ) \\ 0 \text{:} & ( \begin{matrix}NOT included in \\ dominant color\end{matrix} )\end{matrix} , N \text{:} size of rect ) \\ inPlayParam ≡ ( \begin{matrix}DomColRate ( downRightRect ) + \\ DomColRate ( downRightRect )\end{matrix} ) / 2 ( dominantcolor \text{:} grass , ground ) \qquad ( 3 )$$

Finally, the following algorithm is used to optimize the start and end point of the highlight detected. The key scene, before the start point of each highlight scene decided, is searched. If the key scene is detected, the key scene will be adopted as a new start point of highlight scenes. In a similar way, the key scene or in-play scene, behind the end point of each highlight scenes decided, is searched. If the searched scene is detected, the scene will be adopted as a new end point. The method to modify the end point of the highlight scenes varies according to the characteristics of the images.

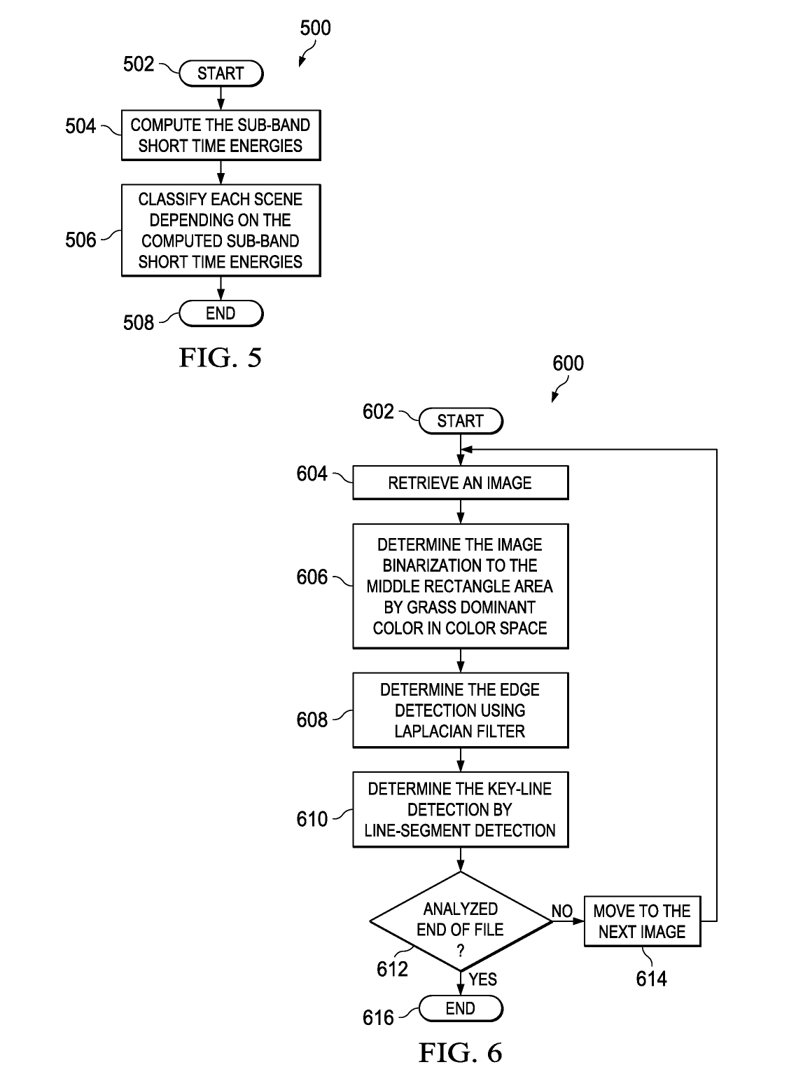

FIG. 5 is a flow diagram depicting an embodiment of an audio based method 500. The method starts at step 502 and proceeds to step 504. At step 504, the method 500 computes the sub-band short-time energies. At step 506, the method 500 classifies each scene depending on the computed sub-band short-time energies.

FIG. 6 is a flow diagram depicting an embodiment of a key scene detection method 600. The method starts at step 602 and proceeds to step 604. At step 604, the method 600 retrieves an image. At step 606, the method 600 determines the image binarization to the middle rectangle area by grass dominant in the color space. At step 608, the method 600 determines the edge detection by utilizing Laplacian filter. At step 610, the method 600 determines the key-line detection by line-segment detection. At step 612, the method 600 determines if end of file is reached. If the method 600 has not reached the end of file, the method 600 proceeds to step 614. At step 614, the method 600 moves to the next image and proceeds to step 604. If it reached the end of file, the method 600 proceeds to step 616. The method 600 ends at step 616.

FIG. 7 is a flow diagram depicting an embodiment of an in-play scene detection method 700. The method 700 starts at step 702 and proceeds to step 704. At step 704, the method 700 retrieves an image. At step 706, the method 700 determines the image binarization to the Down-right and down-left rectangle area by grass and ground color. At step 708, the method 700 calculates and evaluates in-play parameter by use of equation 3. At step 710, the method 700 determined if the end of file is reached. If the method 700 has not reached the end of file, the method 700 proceeds to step 712. At step 712, the method 700 moves to the next image and proceeds to step 704. If the method 700 reached the end of file, the method 700 proceeds to step 714. The method 700 ends at step 714.

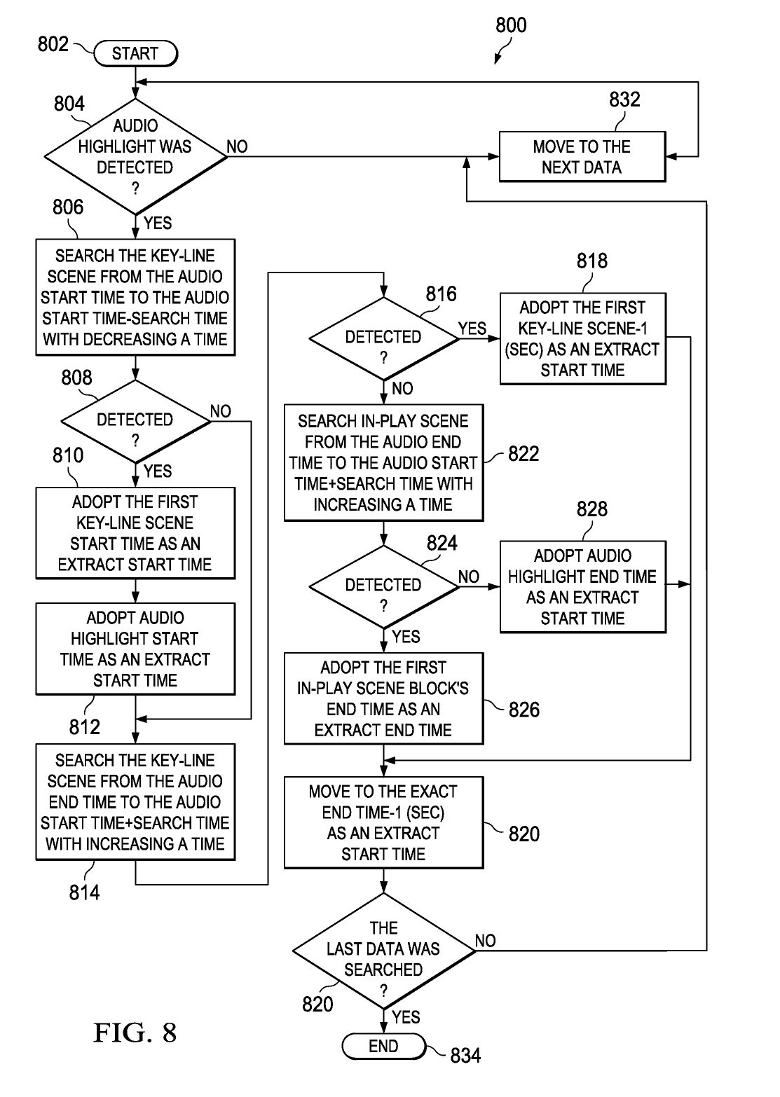

FIG. 8 is a flow diagram depicting an embodiment of a start and end point optimization method 800. The method 800 starts at step 802 and proceeds to step 804. At step 804, the method 800 determines if audio highlight is detected. If audio highlight is not detected, then the method 800 proceeds to step 832. At step 832, the method 800 moves to the next data and proceeds to step 804. If the highlight audio is detected, the method 800 proceeds to step 806. At step 806, the method 800 searches key-line scene from the audio start time to the audio start time minus search time with decreasing a time. At step 808, the method determines if the audio start time is detected. If the audio start time is detected, the method 800 adopts the first key-line scene start time as an exact start time. If the audio start time is not detected, the method 800 proceeds to step 814, wherein the method 800 adopts the audio highlight start time as an exact start time.

The method 800 proceeds from step 810 and step 812 to step 814. At step 814, the method 800 searches key-line scene from the audio end time to the audio start time minus search time with increasing a time. At step 816, the method 800 determines if audio end time is detected. If it is detected the method 800 proceeds to step 818. At step 818, the method 800 adopts the first key-line scene minus 1 second as an exact end time and the method 800 proceeds to step 820. Otherwise, the method 800 proceeds from step 816 to step 822. At step 822, the method 800 searches in-play scene from the audio end time to the audio start time plus searches time with increasing a time. At step 824, the method 800 determines if the audio end time is detected. If the audio end time is detected, the method 800 proceeds to step 826, wherein the method 800 adopts the first in-play scene block's end time as an exact end time and proceeds to step 820. Otherwise, the method 800 proceeds from step 824 to step 828, wherein the method 800 adopts audio highlight end time as an exact end time and proceeds to step 820. At step 820, the method 800 moves to the exact end time plus 1 second and proceeds to step 830. At step 830, the method 800 determines if the last data was found. If the last data was not found, the method 800 proceeds to step 832. Otherwise, the method 800 proceeds to step 834. At step 834, the method 800 ends. It should be noted that the method 800 may perform end point and start point analysis at the same time or in any order.

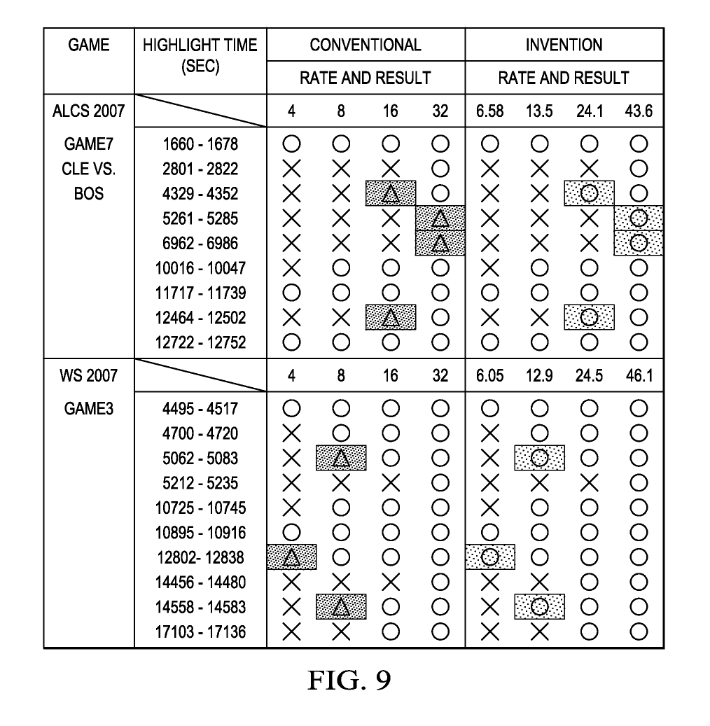

FIG. 9 is an embodiment depicting highlight detection performance improvement as a result of the current invention. For the evaluation of the method and apparatus for highlight detection, a benchmark is prepared which is made of the manually-selected start and end points of highlight. For example, a batter sets in the batter's box (start point), a pitcher throws the ball, the batter hits the ball, and the scoring caption displays (end point).

Statistical evidence supporting the effectiveness of the invention is presented in FIG. 9. In the evaluation, 4%, 8%, 16%, and 32% (in temporal length) of the entire program were extracted using the conventional audio energy based highlight detection technology and the number of scoring opportunities covered in the extracted video made by conventional and invented technology were measured.

Consequently, it led to the improvement highlight detection performance, as shown in FIG. 9. In FIG. 9, the circle symbol (□) means that the highlight is fully detected and the extraction includes the benchmark of highlight. The x-mark (×) means that the benchmark of highlight was not detected at all, while the triangle mark (Δ) means that the benchmark of highlight was detected partially. All the measured highlights that were extracted partially by conventional audio energy based technique were optimized adequately.

While the foregoing is directed to embodiments of the present invention, other and further embodiments of the invention may be devised without departing from the basic scope thereof, and the scope thereof is determined by the claims that follow.

What is claimed is:

1. A method for highlight detection, wherein the method is utilized in a highlight detection apparatus, the method comprising:
retrieving audio and video data;
detecting a high audio energy scene of the retrieved audio data;
detecting a key-line scene relevant to the high audio scene of the retrieved video data;
detecting an in-play scene according to the key-line; and
optimizing start and end point of the highlight scene.

2. The method of claim 1, wherein the step of detecting the in-play parameter utilizes the equation
$$DomColRate ( rect ) ≡ {\sum }_{i ∈ Rect} p ( i ) / N ( p = \{ \begin{matrix}1 \text{:} & ( \begin{matrix}included in \\ dominant color\end{matrix} ) \\ 0 \text{:} & ( \begin{matrix}NOT included in \\ dominant color\end{matrix} )\end{matrix} , N \text{:} size of rect ) \\ inPlayParam ≡ ( \begin{matrix}DomColRate ( downRightRect ) + \\ DomColRate ( downRightRect )\end{matrix} ) / 2 ( dominantcolor \text{:} grass , ground )$$

3. The method of claim 1, wherein the step of optimizing start point comprises:
searching key-line scene from audio start time to the audio start time minus search time with decreasing a time;
adopting the first key-line scene as an exact start time if the start time is detected; and
adopting audio highlight start time as an exact start time if the start time is not detected.

4. The method of claim 1, wherein the step of optimizing end time comprises:
searching key-line scene from audio end time to the audio start time plus search time with decreasing a time;
adopting the first key-line scene minus one second as an exact end time if the end time is detected; and
searching in-play scene from the audio end time to the audio start time plus time with increasing a time if the end time is not detected.

5. The method of claim 4, wherein the step of searching in-play scene from audio end time further comprises:
adopting the first in-play scene block's end time as an exact end time if the end time is detected; and
adopting audio highlight end time as an exact start time if the end time is not detected.

6. The method of claim 1 further comprising outputting audio and video data based on the optimized start and end point.

7. An apparatus for highlight detection of a video, comprising:
means for retrieving audio and video data;
means for detecting a high audio energy scene of the retrieved audio data;
means for detecting a key-line scene relevant to the high audio scene of the retrieved video data;
means for detecting an in-play scene according to the key-line; and
means for optimizing start and end point of the highlight scene.

8. The apparatus of claim 7, wherein the means for detecting the in-play parameter utilizes the equation
$$DomColRate ( rect ) ≡ {\sum }_{i ∈ Rect} p ( i ) / N ( p = \{ \begin{matrix}1 \text{:} & ( \begin{matrix}included in \\ dominant color\end{matrix} ) \\ 0 \text{:} & ( \begin{matrix}NOT included in \\ dominant color\end{matrix} )\end{matrix} , N \text{:} size of rect ) \\ inPlayParam ≡ ( \begin{matrix}DomColRate ( downRightRect ) + \\ DomColRate ( downRightRect )\end{matrix} ) / 2 ( dominantcolor \text{:} grass , ground )$$

9. The apparatus of claim 7, wherein the means for optimizing start point comprises:
means for searching key-line scene from audio start time to the audio start time minus search time with decreasing a time;
means for adopting the first key-line scene as an exact start time if the start time is detected; and
means for adopting audio highlight start time as an exact start time if the start time is not detected.

10. The apparatus of claim 7, wherein the means for optimizing end time comprises:
searching key-line scene from audio end time to the audio start time plus search time with decreasing a time;
means for adopting the first key-line scene minus one second as an exact end time if the end time is detected; and
means for searching in-play scene from the audio end time to the audio start time plus time with increasing a time if the end time is not detected.

11. The apparatus of claim 10, wherein the means for searching in-play scene from audio end time further comprises:
means for adopting the first in-play scene block's end time as an exact end time if the end time is detected; and
means for adopting audio highlight end time as an exact start time if the end time is not detected.

12. The apparatus of claim 7 further comprising means for outputting audio and video data based on the optimized start and end point.

13. A computer readable medium comprising software that, when executed by a processor, causes the processor to perform a method for base-lining a calculator, the method comprising:
retrieving audio and video data;
detecting a high audio energy scene of the retrieved audio data;
detecting a key-line scene relevant to the high audio scene of the retrieved video data;
detecting an in-play scene according to the key-line; and
optimizing start and end point of the highlight scene.

14. The method of claim 13, wherein the step of detecting the in-play parameter utilizes the equation
$$DomColRate ( rect ) ≡ {\sum }_{i ∈ Rect} p ( i ) / N ( p = \{ \begin{matrix}1 \text{:} & ( \begin{matrix}included in \\ dominant color\end{matrix} ) \\ 0 \text{:} & ( \begin{matrix}NOT included in \\ dominant color\end{matrix} )\end{matrix} , N \text{:} size of rect ) \\ inPlayParam ≡ ( \begin{matrix}DomColRate ( downRightRect ) + \\ DomColRate ( downRightRect )\end{matrix} ) / 2 ( dominantcolor \text{:} grass , ground )$$

15. The method of claim 13, wherein the step of optimizing start point comprises:
searching key-line scene from audio start time to the audio start time minus search time with decreasing a time;
adopting the first key-line scene as an exact start time if the start time is detected; and
adopting audio highlight start time as an exact start time if the start time is not detected.

16. The method of claim 13, wherein step of optimizing end time comprises:
searching key-line scene from audio end time to the audio start time plus search time with decreasing a time;
adopting the first key-line scene minus one second as an exact end time if the end time is detected; and
searching in-play scene from the audio end time to the audio start time plus time with increasing a time if the end time is not detected.

17. The method of claim 16, wherein the step of searching in-play scene from audio end time further comprises:
adopting the first in-play scene block's end time as an exact end time if the end time is detected; and
adopting audio highlight end time as an exact start time if the end time is not detected.

18. The method of claim 13 further comprising outputting audio and video data based on the optimized start and end point.
